(19) United States
(12) Patent Application Publication
(10) Pub. No.: US 2025/0178401 A1
(43) Pub. Date: Jun. 5, 2025

(54) INTEGRATED THERMAL MANAGEMENT SYSTEM FOR VEHICLE

(71) Applicants: Hyundai Motor Company, Seoul (KR); Kia Corporation, Seoul (KR)

(72) Inventor: Jonghoon Lee, Hwaseong-si (KR)

(21) Appl. No.: 18/929,912

(22) Filed: Oct. 29, 2024

(30) Foreign Application Priority Data
Dec. 4, 2023 (KR) 10-2023-0173712

(51) Int. Cl. B60H 1/00

(52) U.S. Cl. CPC B60H 1/00278; B60H 1/00385; B60H 1/00885; B60H 2001/00307; B60H 2001/00935; B60H 2001/00949

(57) ABSTRACT

An embodiment integrated thermal management system for a vehicle-mounted power electric device and a vehicle interior includes a reservoir configured to store a coolant, a first cooling circuit in which the coolant branched and supplied from the reservoir circulates and passes through a first heat exchanger and a first radiator, a second cooling circuit in which the coolant branched and supplied from the reservoir circulates and passes through a second heat exchanger and a second radiator, a third cooling circuit in which the coolant branched and supplied from the reservoir circulates and passes through a third radiator and passes through the first radiator of the first cooling circuit, and a fourth cooling circuit including a compressor in heat exchange with the first heat exchanger and the second heat exchanger, wherein the first, second, third, and fourth cooling circuits are configured to heat exchange through the same coolant.

### CROSS-REFERENCE TO RELATED APPLICATIONS

This application claims the benefit of Korean Patent Application No. 10-2023-0173712, filed on Dec. 4, 2023, which application is hereby incorporated herein by reference.

### TECHNICAL FIELD

The present disclosure relates to an integrated thermal management system for a vehicle.

### BACKGROUND

Recently, future mobility visions with new concepts for implementing human-oriented dynamic future cities have been introduced in vehicle industries. One of the future mobility solutions is a purpose-built vehicle (PBV) as a purpose-based mobility vehicle.

Examples of the PBV may include an environmentally friendly movable vehicle based on an electric vehicle (EV). The PBVs may provide various customized services to users while the PBVs move from starting points to destinations in an unmanned or manned autonomous driving manner.

A vehicle body of the PBV includes an under body (also called a chassis frame, a rolling chassis, or a skateboard in the art) and an upper body assembled to the under body.

In this case, the upper body may have various shapes depending on the type of customized service provided by the PBV. For example, the PBV may be used as a hailing type vehicle having cabins respectively disposed at front and rear sides of the upper body. Further, the PBV may also be used as a cab type vehicle having a cabin only provided at the front side of the upper body. Furthermore, the PBV may also be used as a delivery type vehicle having a cabin provided at the front side of the upper body and a luggage room provided at the rear side.

For thermal management of the PBV, air conditioning and cooling devices are applied. The air conditioning device is to make the heat exchange between air and coolant, air and refrigerant, and air and a positive temperature coefficient (PTC) heater, and the cooling device is to make the heat exchange between air and coolant and air and refrigerant, which makes the control of heat flow complicated and not easy. To implement this, a number of heat exchangers such as a low temperature radiator, a high temperature radiator, a condenser, a room condenser, a second heat exchanger, an integrated chiller, and a number of devices such as three three-way valves, two expansion valves, and the like are added.

In addition, an air conditioning system is mounted in the interior, a cooling module is mounted in the front of the vehicle, and an integrated control module is positioned in a power electric (PE) room, which requires a lot of time for assembly and disassembly and a lot of time for degassing.

Therefore, there is a need to develop an integrated thermal management system for the PBV.

### SUMMARY

The present disclosure relates to an integrated thermal management system for a vehicle. Particular embodiments relate to an integrated thermal management system that controls the heating and cooling of a battery, a PE device, and a vehicle interior as applied to a PBV that is an electric vehicle.

Therefore, according to an embodiment of the present disclosure, there is provided an integrated thermal management system that is mounted on a space module in a PBV that is an electric vehicle and can control the heating and cooling of a battery, a PE device, and a vehicle interior according to the outside air temperature.

There is provided an integrated thermal management system for a vehicle-mounted PE device and a vehicle interior. According to an embodiment of the present disclosure, the integrated thermal management system may include a reservoir configured to store a coolant, a first cooling circuit in which the coolant branched and supplied from the reservoir circulates and passes through a first heat exchanger and a first radiator, a second cooling circuit in which the coolant branched and supplied from the reservoir circulates and passes through a second heat exchanger and a second radiator, a third cooling circuit in which the coolant branched and supplied from the reservoir circulates and passes through a third radiator and passes through the first radiator of the first cooling circuit, and a fourth cooling circuit including a compressor in heat exchange with the first heat exchanger and the second heat exchanger, in which the first cooling circuit, the second cooling circuit, the third cooling circuit, and the fourth cooling circuit may heat exchange through the same coolant.

There is provided an integrated thermal management system according to an embodiment of the present disclosure that may include a first mode in which heat exchange of the third cooling circuit is performed, a second mode in which the second cooling circuit and the first cooling circuit are operated in parallel, a third mode in which the second cooling circuit is branched from a branch point of the second cooling circuit, coupled to the third cooling circuit in series and passes through the third cooling circuit, and coupled to the first cooling circuit at a branch point of the first cooling circuit, a fourth mode in which the second cooling circuit and the first cooling circuit are operated in parallel and the second cooling circuit and the third cooling circuit are operated in parallel, and a fifth mode in which the second cooling circuit and the first cooling circuit are operated in parallel and the second cooling circuit is branched from the branch point of the second cooling circuit and operated with the third cooling circuit in parallel to be coupled to a first heat exchange loop at a branch point of the first heat exchange loop.

The first to fifth mode may be controlled through opening and closing of a three-way valve.

The integrated thermal management system, according to an embodiment of the present disclosure, may further include a first coolant pump configured to deliver coolant branched and supplied from the reservoir through a coolant flow path in the first cooling circuit.

The integrated thermal management system, according to an embodiment of the present disclosure, may further include a second coolant pump configured to deliver coolant branched and supplied from the reservoir through a coolant flow path.

The integrated thermal management system, according to an embodiment of the present disclosure, may further include a battery and a PE device, which are cooled in the third cooling circuit by coolant branched and supplied from the reservoir, the coolant being introduced through a coolant flow path by operation of a three-way valve.

The PE device may include a motor/inverter and an integrated charging control unit (ICC).

The integrated thermal management system, according to an embodiment of the present disclosure, may further include a four-way valve configured to be connected to refrigerant passing through the compressor and to select and control one of the first heat exchanger and the second heat exchanger to serve as the first heat exchanger and an expansion valve configured to expand the condensed refrigerant in the fourth cooling circuit.

The integrated thermal management system, according to an embodiment of the present disclosure, may further include an accumulator in a flow path before passing through the compressor.

A first air flow path may be formed in which air flows from the first radiator to the third radiator.

In the integrated thermal management system, according to an embodiment of the present disclosure, a second air flow path may be formed in which air flows from the second radiator to the vehicle interior, and a flap valve may be provided between the first air flow path and the second air flow path to be opened and closed to allow air to pass selectively.

When the PE device is mounted on the vehicle and the vehicle is heated or cooled, in the first air flow path, air is introduced from the exterior and air is delivered from the second air flow path, a portion of which may be delivered to the exterior and another portion of which may be delivered to the second radiator in front of the second air flow path, and in the second air flow path, air is introduced from the exterior and a portion of air is delivered from the first air flow path, a portion of which may be delivered to the interior and another portion of which may be delivered to the first radiator in front of the first air flow path.

When the outside air temperature is at a level of 25° C. and the battery and the PE device are normally cooled, the first coolant pump is stopped, the three-way valve is opened toward the PE device, a cut off valve of the third radiator is opened, and the compressor is stopped, so that the PE device may be cooled through coolant flowing through the third cooling circuit.

The second radiator is stopped and the flap valve is closed so that air introduced from the exterior may pass through the first radiator and the third radiator and may be cooled and discharged to the exterior.

When the outside air temperature is at a level of 25° C. and heat generation of the PE device is high, both the first coolant pump and the second coolant pump are opened, the three-way valve is opened toward the second heat exchanger, and coolant circulates through the compressor, the four-way valve, the first heat exchanger, the expansion valve, and the second heat exchanger, so that the coolant flowing through the first heat exchanger may cool the refrigerant, and the coolant may be cooled through the refrigerant in the second heat exchanger and delivered toward the PE device to cool the PE device.

The second radiator is stopped and the flap valve is closed so that air introduced from the exterior may pass through the first radiator and the third radiator and may be cooled and discharged to the exterior.

When the outside air temperature is at a level higher than 25° C., both the first coolant pump and the second coolant pump are opened, and the three-way valve is opened, the coolant is delivered toward the PE device through a branch point to cool the PE device, and the refrigerant circulates through the compressor, the four-way valve, the first heat exchanger, the expansion valve, and the second heat exchanger, so that the coolant flowing through the first heat exchanger may cool the refrigerant, and the coolant may be cooled through the refrigerant in the second heat exchanger and passes through the second radiator.

The first radiator, the second radiator, and the third radiator are all operated and the flap valve is closed, so that cold air passing through the second radiator may be introduced into the interior.

When the outside air temperature is at a level higher than 25° C. and heat generation of the PE device is high, both the first coolant pump and the second coolant pump are opened, and the three-way valve is opened toward the second heat exchanger, the coolant is delivered from the second heat exchanger toward the PE device to cool the PE device, and the refrigerant circulates through the compressor, the four-way valve, the first heat exchanger, the expansion valve, and the second heat exchanger, so that the coolant flowing through the first heat exchanger may cool the refrigerant, and the coolant may be cooled through the refrigerant in the second heat exchanger and pass through the second radiator.

The first radiator, the second radiator, and the third radiator are all operated and the flap valve is opened, so that of the cold air passing through the second radiator, a portion may be introduced into the interior and a portion may flow in front of the first radiator through the open flap valve to further cool the coolant flowing to the reservoir.

When the outside temperature is at a level higher than 25° C. and only the interior is cooled, both the first coolant pump and the second coolant pump are opened, the three-way valve is opened toward the second heat exchanger, and the refrigerant circulates through the compressor, the four-way valve, the first heat exchanger, the expansion valve, and the second heat exchanger, so that the coolant flowing through the first heat exchanger may cool the refrigerant, and the coolant may be cooled through the refrigerant in the second heat exchanger and pass through the second radiator.

The third radiator is stopped and the flap valve is closed, so that air introduced from the exterior may be introduced into the interior in front of the second radiator.

When the outside air temperature is at a level lower than 25° C., the temperature of the battery and the PE device is raised, and the interior is heated, the four-way valve is operated in reverse, so that the first heat exchanger and the second heat exchanger may switch functions to function as a heat pump.

Meanwhile, there is provided a method of controlling an integrated thermal management system. According to an embodiment of the present disclosure, the method may include setting a target temperature, reading information on sensors, determining a difference between the target temperature and a current temperature, identifying a number of cases with a combination of modes to achieve a temperature, identifying a mode of optimal energy consumption and a time to reach, and determining whether a user is satisfied with the time to reach, in which a performance profile may be operated to change a time by changing a mode when there is a response from the user.

According to an embodiment of the present disclosure, it is possible to configure the cooling and air conditioning systems to be applicable not only in electric vehicles but also in general residential facilities and to modularize the system for easy disassembly and assembly so that the system can be used universally across industries.

In addition, the cooling and air conditioning systems can be integrated to reduce wiring and piping, and the amount of refrigerant can be reduced to reduce cost and weight.

In addition, it is possible to configure the system to have heat exchange between air and coolant and between coolant and refrigerant and to have the efficient control of the entire system through the temperature of the coolant.

In addition, it is possible to improve the complexity of the system, such as reducing the heat exchanger, to improve efficiency and reduce costs by using the heat pump function, and to improve the function of the heat pump, which is difficult to use at extremely low temperatures, through the adjustment of the air flow path, thereby enabling the elimination of the PTC air conditioning heater and the coolant battery heater.

In addition, condensation and moisture generated inside the device after a cooling operation can be removed and dehumidified through adjusting the internal air flow path.

In addition, it is possible to reduce FET application costs by switching all of the electric air conditioner compressor, the PTC heater, the coolant heater, the cooling fan, and the water pump that apply a high voltage to 48V and to reduce the number of components and control of current by unifying the power system of the device and to select a motor with an optimal operating point in consideration.

In addition, it is possible to minimize energy consumption by calculating and adjusting the circuit of the heat exchanging device, the flow rate and temperature of the flow path, the pressure, and the target temperature time.

### BRIEF DESCRIPTION OF THE DRAWINGS

FIG. 1 is a view schematically illustrating an integrated thermal management system according to an embodiment of the present disclosure, as viewed from the front.

FIG. 2 is a view schematically illustrating the integrated thermal management system mounted on a vehicle according to an embodiment of the present disclosure.

FIG. 3 is a view schematically illustrating the integrated thermal management system according to an embodiment of the present disclosure, as viewed from the top.

FIG. 4 is a circuit diagram illustrating a fluid flow of the integrated thermal management system according to an embodiment of the present disclosure.

FIG. 5 is a view illustrating an air flow in an air flow path of the integrated thermal management system according to an embodiment of the present disclosure.

FIG. 6 is a circuit diagram illustrating a fluid flow in the integrated thermal management system according to an embodiment of the present disclosure, when the outside air temperature is at the level of 25° C., and for normal cooling of a battery and a PE device.

FIG. 7 is a view illustrating an air flow in an air flow path in the case of FIG. 6.

FIG. 8 is a circuit diagram illustrating a fluid flow in the integrated thermal management system according to an embodiment of the present disclosure, when the outside air temperature is at the level of 25° C. and the PE device has high heat generation.

FIG. 9 is a view illustrating an air flow in an air flow path in the case of FIG. 8.

FIG. 10 is a circuit diagram illustrating a fluid flow in the integrated thermal management system according to an embodiment of the present disclosure, when the outside air temperature is at a level higher than 25° C.

FIG. 11 is a view illustrating an air flow in an air flow path in the case of FIG. 10.

FIG. 12 is a circuit diagram illustrating a fluid flow in the integrated thermal management system according to an embodiment of the present disclosure, when the outside air temperature is at a level higher than 25° C. and the PE device has high heat generation.

FIG. 13 is a view illustrating an air flow in an air flow path in the case of FIG. 12.

FIG. 14 is a circuit diagram illustrating a fluid flow in the integrated thermal management system according to an embodiment of the present disclosure, when the outside air temperature is at a level higher than 25° C. and only an interior is cooled.

FIG. 15 is a view illustrating an air flow in an air flow path in the case of FIG. 14.

FIG. 16 is a circuit diagram illustrating a fluid flow in the integrated thermal management system according to an embodiment of the present disclosure, when the outside air temperature is at a level lower than 25° C., the temperature of the battery and PE device is raised, and the interior is heated.

FIG. 17 is a view illustrating an air flow in the air flow path for increasing heating efficiency and dehumidification in the case of FIG. 16.

FIG. 18 is a view illustrating an air flow in the air flow path for increasing heat exchange efficiency and improving heat pump performance in the case of FIG. 16.

FIG. 19 is a flowchart illustrating a method of controlling the integrated thermal management system according to an embodiment of the present disclosure.

### DETAILED DESCRIPTION OF ILLUSTRATIVE EMBODIMENTS

Hereinafter, embodiments of the present disclosure will be described in detail with reference to the accompanying drawings so that those with ordinary skill in the art to which the present disclosure pertains may easily carry out the embodiments. Embodiments of the present disclosure may be implemented in various different ways and are not limited to the embodiments described herein.

In addition, the constituent elements having the same configurations in several embodiments will be assigned with the same reference numerals and described only in the representative embodiment, and only the constituent elements, which are different from the constituent elements according to the representative embodiment, will be described in other embodiments.

It is noted that the drawings are schematic and are not illustrated based on actual scales. Relative dimensions and proportions of parts illustrated in the drawings are exaggerated or reduced in size for the purpose of clarity and convenience in the drawings, and any dimension is just illustrative but not restrictive. Further, the same reference numerals designate the same structures, elements, or components illustrated in two or more drawings in order to exhibit similar characteristics. When one component is described as being positioned “above” or “on” another component, one component can be positioned “directly on” another component, and one component can also be positioned on another component with other components interposed therebetween.

The embodiments of the present disclosure specifically illustrate example embodiments of the present disclosure. As a result, various modifications of the drawings are expected. Therefore, the embodiments are not limited to specific forms in regions illustrated in the drawings, and for example, include modifications of forms by the manufacture thereof.

Hereinafter, with reference to the accompanying drawings, an integrated thermal management system according to embodiments of the present disclosure will be described in detail.

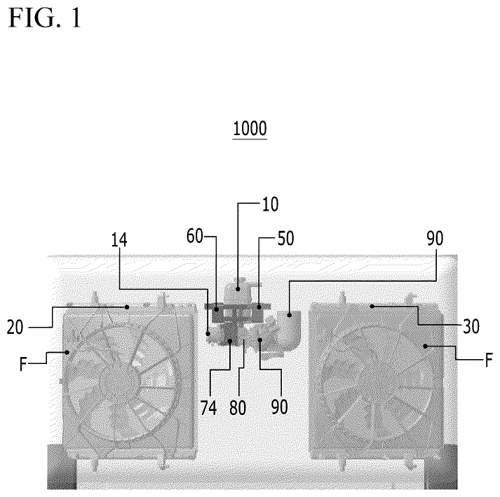

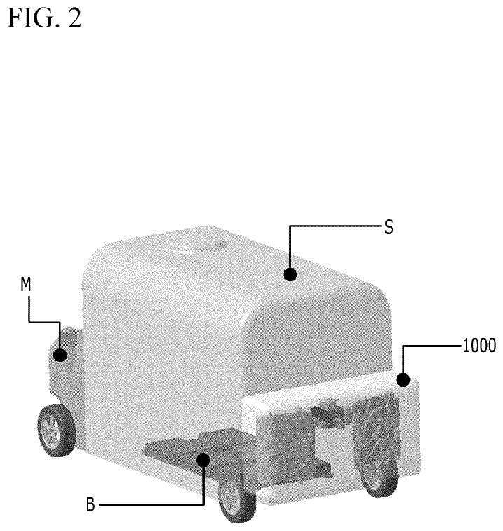

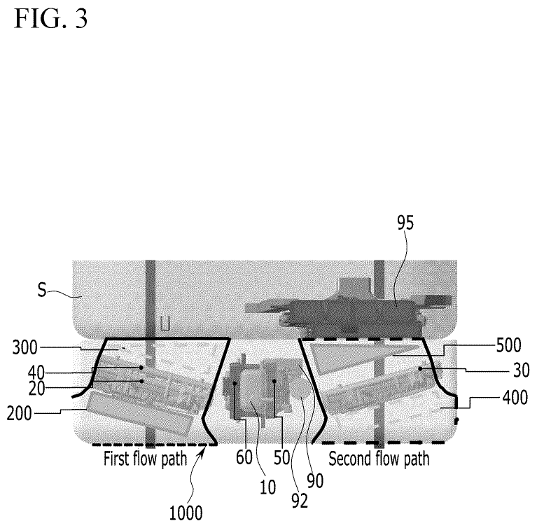

FIG. 1 is a view schematically illustrating an integrated thermal management system according to an embodiment of the present disclosure, as viewed from the front, FIG. 2 is a view schematically illustrating the integrated thermal management system mounted on a vehicle according to an embodiment of the present disclosure, and FIG. 3 is a view schematically illustrating the integrated thermal management system according to one embodiment of the present disclosure, as viewed from the top.

With reference to FIGS. 1 to 3, an integrated thermal management system 1000 according to an embodiment of the present disclosure may be applied to, for example, a purpose built vehicle (hereinafter referred to as a “PBV”).

The PBV may be used as a life modular vehicle based on an electric vehicle that provides various customized services to a user during the time the PBV is moving from an origin to a destination.

In one embodiment, the PBV may be built in a one box type design with a large interior space. Furthermore, the PBV may be applied with a face-to-face type of seating in the interior space.

The vehicle body of such a PBV is suitable for low-volume production of various vehicle types with a small number of parts and may be made in various shapes and sizes.

Furthermore, the vehicle body of the PBV includes a skateboard-type under body (also commonly referred to as a “rolling chassis” or “chassis frame” by those skilled in the art) and an upper body assembled to the under body.

Parts such as a battery assembly, a drive motor, and the like may be mounted on the under body. Further, the upper body is a body in white (BIW) body coupled to the under body, which may include a cabin and luggage room with a large interior space.

The integrated thermal management system 1000 according to an embodiment of the present disclosure may be applied to a structure in which the upper body may be applied to the under body of various shapes and uses, depending on the kind of customized service of the PBV.

To this end, the vehicle body structure to which the integrated thermal management system 1000 is applied according to an embodiment of the present disclosure is the upper body, which includes a drive module M and a space module S coupled to the rear of the drive module M.

The integrated thermal management system 1000 according to an embodiment of the present disclosure may be mounted at the rear of the space module S of the PBV, which comprises the drive module M and the space module S being attached to or detached from the rear of the drive module M.

The integrated thermal management system 1000 according to an embodiment of the present disclosure includes a reservoir 10 that stores coolant, a first coolant pump 12 and a second coolant pump 14 that deliver the coolant branched and supplied from the reservoir 10 through a coolant flow path, a first radiator 20 and a second radiator 30 through which air introduced from the exterior and the coolant supplied and circulating from the reservoir 10 pass, and a third radiator 40 through which air introduced from the first radiator 20 and the coolant supplied and circulating from the reservoir 10 pass.

In addition, the integrated thermal management system 1000 according to an embodiment of the present disclosure may include a first heat exchanger 50 in which refrigerant circulating within the system 1000 is condensed, a second heat exchanger 60 in which the refrigerant condensed in the first heat exchanger 50 is cooled upon evaporation, and a compressor 90 in which the refrigerant delivered from the second heat exchanger 60 is compressed.

In addition, the system 1000 may further include an expansion valve 80 that expands the refrigerant before the refrigerant condensed in the first heat exchanger 50 is supplied to the second heat exchanger 60.

Meanwhile, the first radiator 20, the second radiator 30, and the third radiator 40 are provided at the rear of the space module S, and the first radiator 20 and the third radiator 40 may be disposed in a stacked form in a lengthwise direction of the vehicle from one side. The second radiator 30 may be disposed at a lateral portion of the first radiator 20 and the third radiator 40. A fan F may be attached to the outer sides of the first radiator 20 and the second radiator 30 to create an air flow to allow heat exchange to smoothly occur in the radiators 20, 30, and 40.

As illustrated in FIG. 3, a first air flow path may be formed in which air flows from the first radiator 20 to the third radiator 40, and a second air flow path may be formed in which air flows from the second radiator 30 to the vehicle interior.

In the first air flow path, separately from an exterior inlet through which air is drawn into the first radiator 20, there is formed an upper inlet 200 through which air delivered from the second air flow path is introduced into the first radiator 20 and a lower outlet 300 through which air is discharged from the third radiator 40 to the exterior and the second radiator 30 via the first radiator 20.

In addition, in the second air flow path, separately from an exterior inlet through which air is drawn into the second radiator 30, there is formed a lower inlet 400 through which air delivered from the first air flow path is introduced into the second radiator 30 and an upper outlet 500 that delivers air to the first radiator 20 via the second radiator 30.

In addition, the second air flow path has an interior connection portion formed therein through which air is delivered to the interior via the second radiator 30 and an interior distributor 95 is connected to the interior connection portion.

With the structure of the first air flow path and the second air flow path as described above, when the PE device mounted on the vehicle and the vehicle are heated or cooled, of air introduced from the exterior and air delivered from the second air flow path, a portion is delivered to the exterior and another portion is delivered to the second radiator 30 in front of the second air flow path from the first air flow path. Of the air introduced from the exterior and a portion of air delivered from the first air flow path, a portion may be delivered to the interior and another portion may be delivered to the first radiator 20 in front of the first air flow path from the second air flow path.

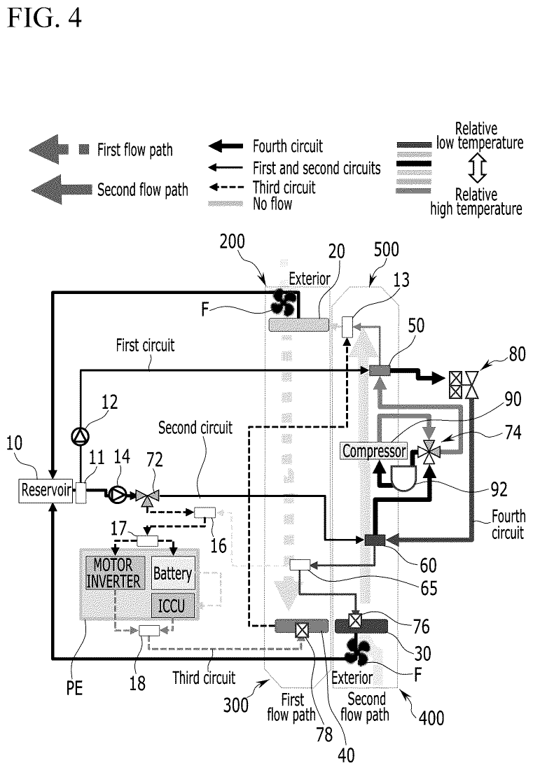

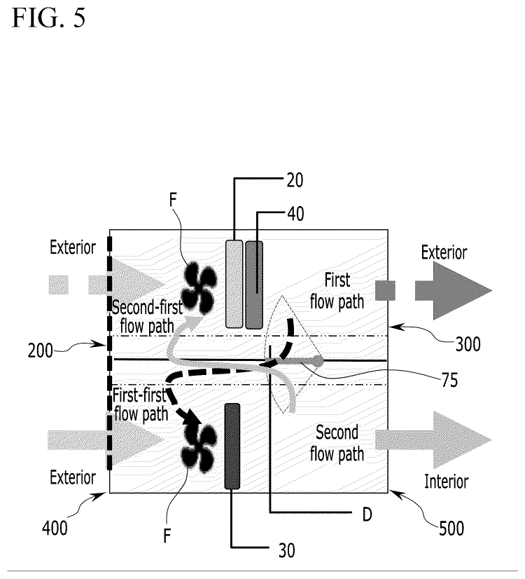

FIG. 4 is a circuit diagram illustrating a fluid flow of the integrated thermal management system according to an embodiment of the present disclosure, and FIG. 5 is a view illustrating an air flow in an air flow path of the integrated thermal management system according to an embodiment of the present disclosure.

With reference to FIG. 4, the integrated thermal management system 1000, according to an embodiment of the present disclosure, may further include a battery and a power electric (PE) device that provides power and a driving force to the vehicle and is cooled by coolant introduced through the second coolant pump 14 and the third radiator 40. The PE device may include a motor/inverter and an integrated charging control unit (ICCU).

The integrated thermal management system 1000, according to an embodiment of the present disclosure, may further include a three-way valve 72 that is provided in a coolant flow path at the rear of the second coolant pump 14 and is opened and closed to selectively deliver coolant from the reservoir 10 to the PE device and the second heat exchanger 60.

In addition, the system 1000 may further include a four-way valve 74 that is provided in the refrigerant flow path between the first heat exchanger 50 and the second heat exchanger 60 and is opened and closed to allow refrigerant that has passed through the compressor 90 to be delivered to the first heat exchanger 50 or refrigerant that has passed through the second heat exchanger 60 to be delivered to the compressor 90.

An accumulator 92 may be further included in the refrigerant flow path between the four-way valve 74 and the compressor 90, where the refrigerant that has passed through the four-way valve 74 is stored, and an expansion valve 80, where the refrigerant condensed in the first heat exchanger 50 is expanded before being supplied to the second heat exchanger 60.

As illustrated in FIG. 5, the integrated thermal management system 1000 according to an embodiment of the present disclosure may have the first air flow path through which air flows from the first radiator 20 to the third radiator 40 and the second air flow path through which air flows from the second radiator 30 to the interior of the vehicle, and a flap valve 75 may be provided between the first and second air flow paths to be opened and closed to selectively allow air to pass through.

With reference to FIG. 4, the integrated thermal management system 1000 according to an embodiment of the present disclosure may be configured with a first cooling circuit to a fourth cooling circuit.

The first cooling circuit flows coolant from the reservoir 10 to the first coolant pump 12 and the first heat exchanger 50, the second cooling circuit flows coolant from the reservoir 10 to the second coolant pump 14, the three-way valve 72, and the second heat exchanger 60, the third cooling circuit flows coolant from the reservoir 10 to the second coolant pump 14, the three-way valve 72, the PE device, and the third radiator 40, and the fourth cooling circuit flows the refrigerant from the first heat exchanger 50 to the thermal expansion valve 80 and the second heat exchanger 60.

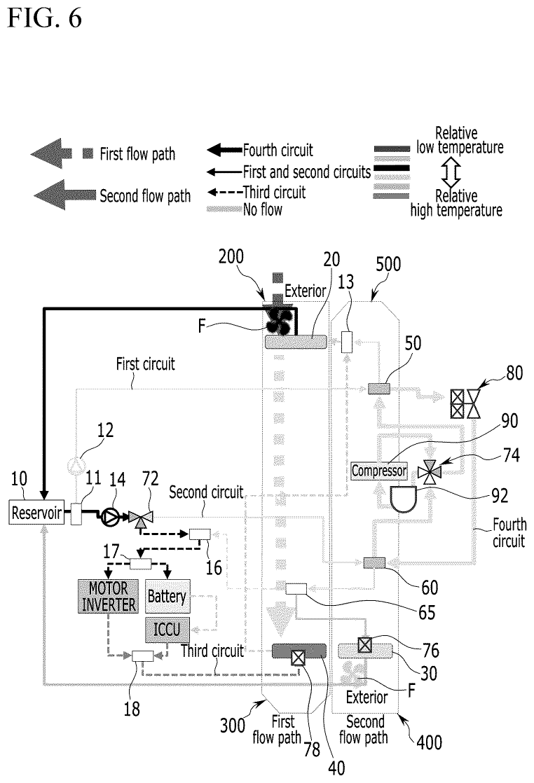

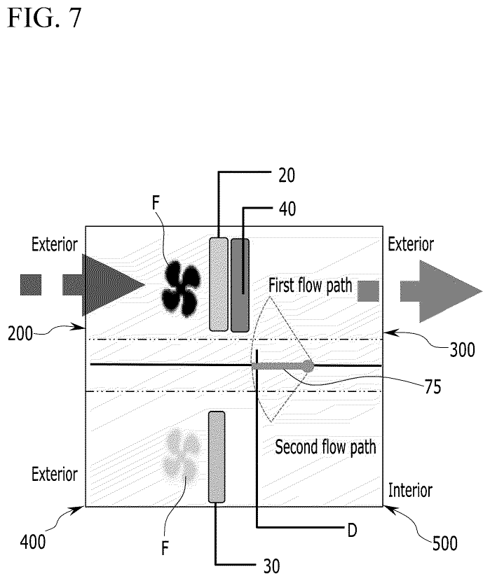

FIG. 6 is a circuit diagram illustrating a fluid flow in the integrated thermal management system according to an embodiment of the present disclosure, when the outside air temperature is at the level of 25° C., and for normal cooling of the battery and the PE device, and FIG. 7 is a view illustrating an air flow in an air flow path in the case of FIG. 6.

With reference to FIG. 6, when the outside air temperature is at the level of 25° C. and the battery and the PE device are normally cooled, the first coolant pump 12 is stopped and no coolant flows into the first cooling circuit. The three-way valve 72 is opened to the PE device side, a cut off valve 78 of the third radiator 40 is opened, and the compressor 90 is stopped. In this case, the coolant may flow through the third cooling circuit to cool the PE device.

In addition, as illustrated in FIGS. 6 and 7, the second radiator 30 is stopped, and the flap valve 75 is closed, so that in the first air flow path, air introduced from the exterior may be discharged to the exterior via the first radiator 20 and the third radiator 40.

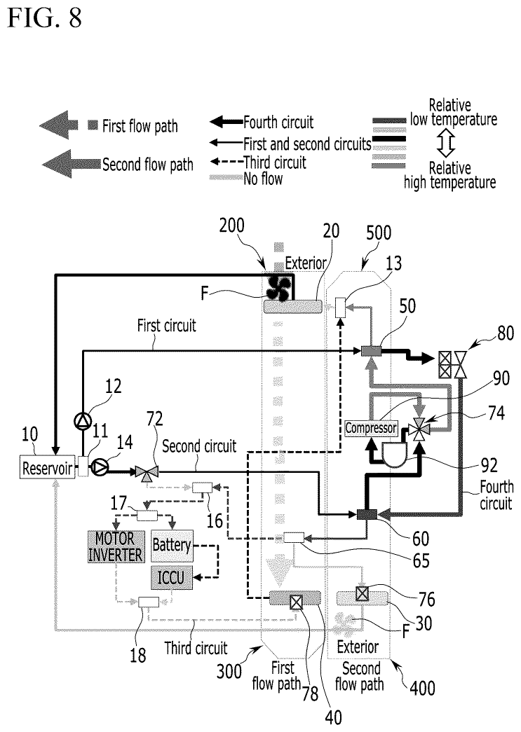

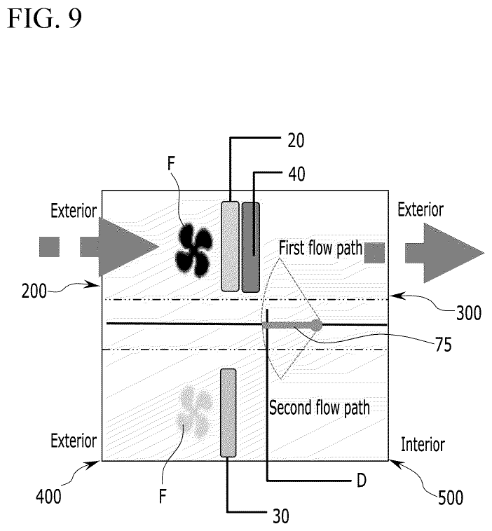

FIG. 8 is a circuit diagram illustrating a fluid flow in the integrated thermal management system according to an embodiment of the present disclosure, when the outside air temperature is at the level of 25° C. and the PE device has high heat generation, and FIG. 9 is a view illustrating an air flow in an air flow path in the case of FIG. 8.

With reference to FIG. 8, when the outside air temperature is at the level of 25° C. and the heat generation of the PE device is high, in this case of further cooling the battery and the PE device using the second heat exchanger 60, both the first coolant pump 12 and the second coolant pump 14 are opened, and the three-way valve 72 is opened to the second heat exchanger 60 side.

The coolant from the second heat exchanger 60 is delivered toward the PE device to cool the PE device, and the refrigerant may circulate through the compressor 90, the four-way valve 74, the first heat exchanger 50, the expansion valve 80, and the second heat exchanger 60 to further cool the coolant leaving the second heat exchanger 60, and the cooled coolant may further cool the PE device.

In addition, as illustrated in FIGS. 8 and 9, the second radiator 30 is stopped, and the flap valve 75 is closed, so that in the first air flow path, air introduced from the exterior may be discharged to the exterior via the first radiator 20 and the third radiator 40.

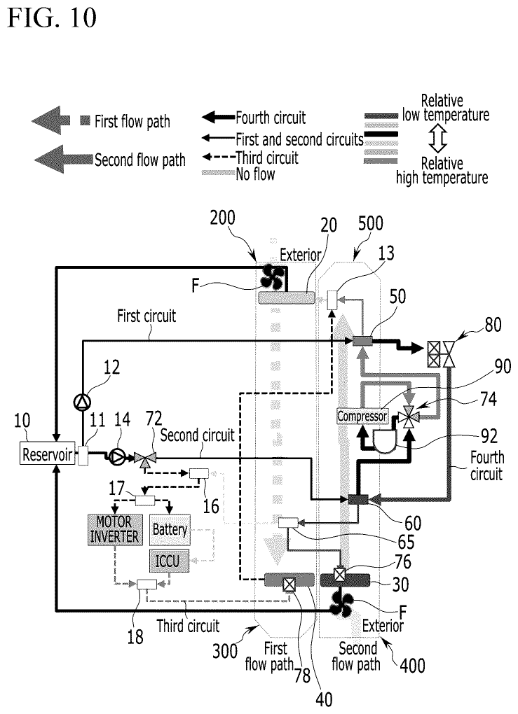

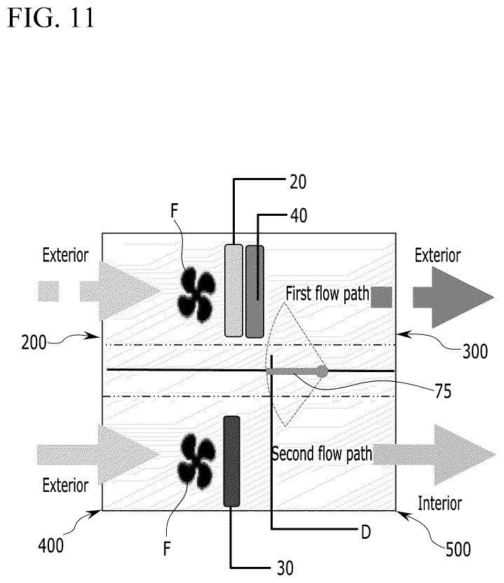

FIG. 10 is a circuit diagram illustrating a fluid flow in the integrated thermal management system according to an embodiment of the present disclosure, when the outside air temperature is at a level higher than 25° C., and FIG. 11 is a view illustrating an air flow in an air flow path in the case of FIG. 10.

When the outside air temperature is at a level higher than 25° C., in this case to cool the battery and the PE device and to cool the interior, both the first coolant pump 12 and the second coolant pump 14 are opened, and the three-way valve 72 is opened toward the second heat exchanger 60 and the PE device side.

The coolant is delivered from the second heat exchanger 60 toward the PE device to cool the PE device, the refrigerant circulates through the compressor 90, the four-way valve 74, the first heat exchanger 50, the expansion valve 80, and the second heat exchanger 60 to further cool the coolant leaving the second heat exchanger 60, and the cooled coolant cools the second radiator 30.

In addition, as illustrated in FIGS. 10 and 11, the first radiator 20, the second radiator 30, and the third radiator 40 are all operated, and the flap valve 75 is closed, so that in the second air flow path, cold air that has passed through the second radiator 30 may be introduced into the interior.

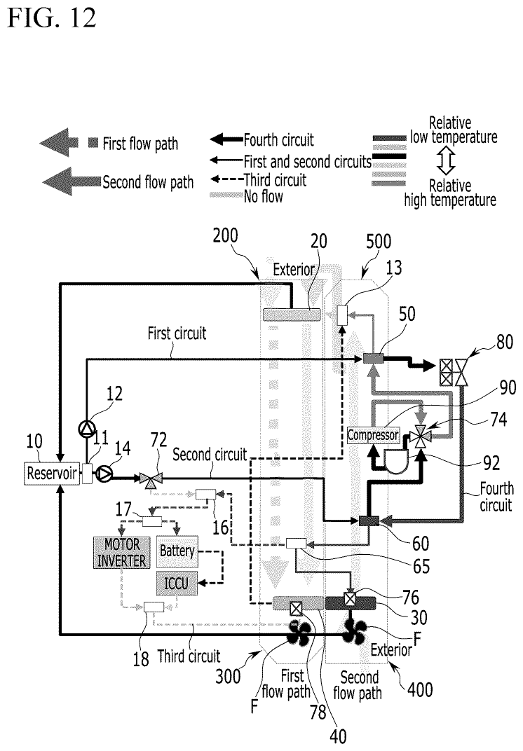

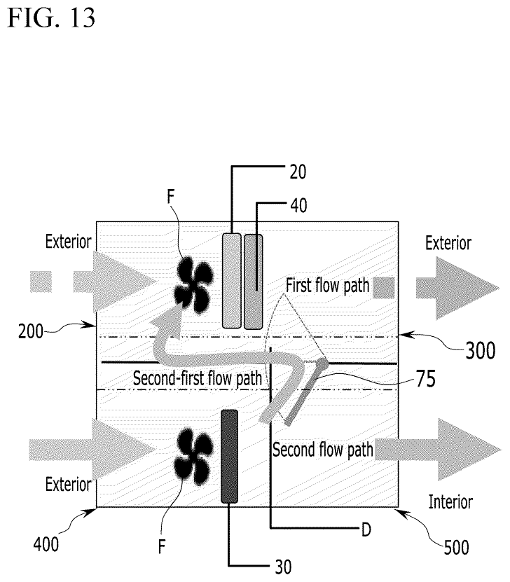

FIG. 12 is a circuit diagram illustrating a fluid flow in the integrated thermal management system according to an embodiment of the present disclosure, when the outside air temperature is at a level higher than 25° C. and the PE device has high heat generation, and FIG. 13 is a view illustrating an air flow in an air flow path in the case of FIG. 12.

With reference to FIG. 12, when the outside air temperature is at a level higher than 25° C. and the heat generation of the PE device is high, in this case, additional cooling is performed using interior air and the second heat exchanger while simultaneous heating of the interior is performed.

Both the first coolant pump 12 and the second coolant pump 14 are opened, and the three-way valve 72 is opened to the second heat exchanger 60 side.

The coolant is delivered from the second heat exchanger 60 toward the PE device to cool the PE device, and the refrigerant circulates through the compressor 90, the four-way valve 74, the first heat exchanger 50, the expansion valve 80, and the second heat exchanger 60 to further cool the coolant leaving the second heat exchanger 60, and the cooled coolant further cools the PE device and also cools the second radiator 30.

In addition, as illustrated in FIGS. 12 and 13, the first radiator 20, the second radiator 30, and the third radiator 40 are all operated, the flap valve 75 is opened, and cold air passing through the second radiator 30, some of which is introduced into the interior, and some of which flows to the front of the first radiator 20 through the open flap valve 75, may further cool the battery and the PE device.

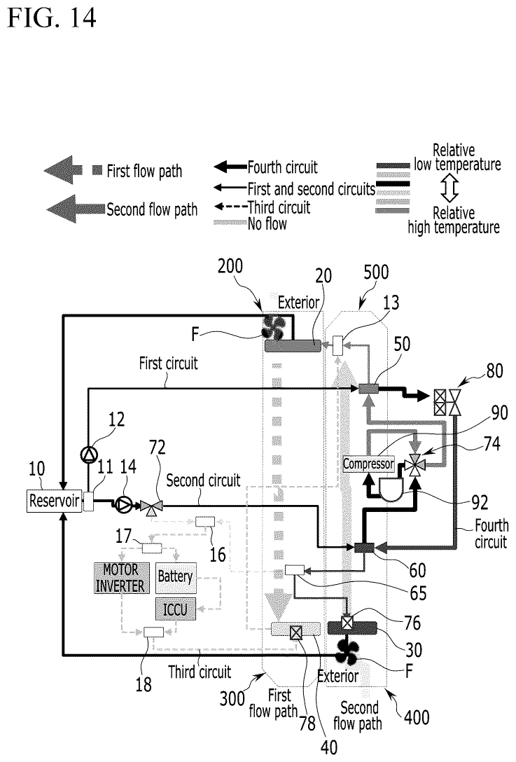

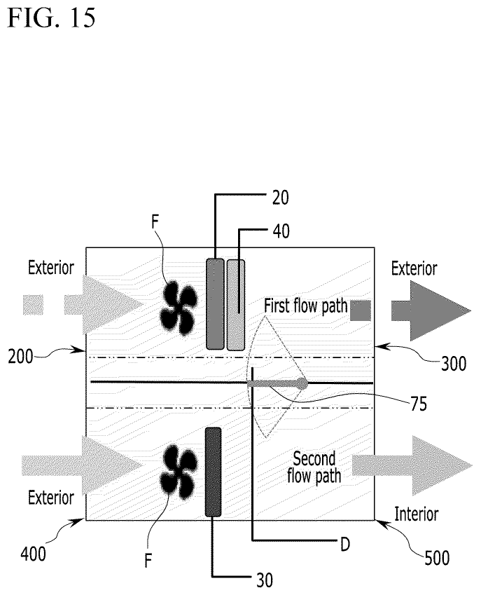

FIG. 14 is a circuit diagram illustrating a fluid flow in the integrated thermal management system according to an embodiment of the present disclosure, when the outside air temperature is at a level higher than 25° C. and only an interior is cooled, and FIG. 15 is a view illustrating an air flow in an air flow path in the case of FIG. 14.

With reference to FIG. 14, when the outside air temperature is at a level higher than 25° C., and only the interior is cooled, both the first coolant pump 12 and the second coolant pump 14 are opened, and the three-way valve 72 is opened to the second heat exchanger 60 side.

The coolant is delivered from the second heat exchanger 60 toward the second radiator 30 to cool the second radiator 30, and the refrigerant circulates through the compressor 90, the four-way valve 74, the first heat exchanger 50, the expansion valve 80, and the second heat exchanger 60 to further cool the coolant leaving the second heat exchanger 60, and the cooled coolant may further cool the second radiator 30.

In addition, as illustrated in FIGS. 14 and 15, the first radiator 20, the second radiator 30, and the third radiator 40 are all operated, and the flap valve 75 is closed, so that in the second air flow path, air introduced from the exterior may be introduced into the interior from the front of the second radiator 30.

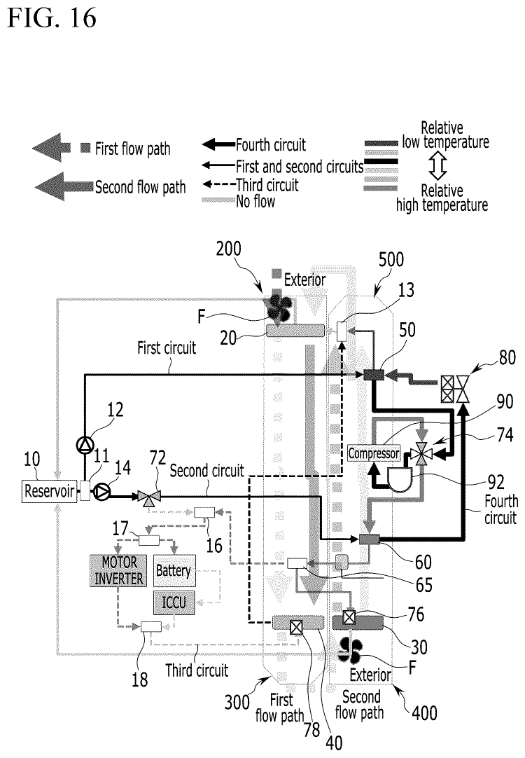

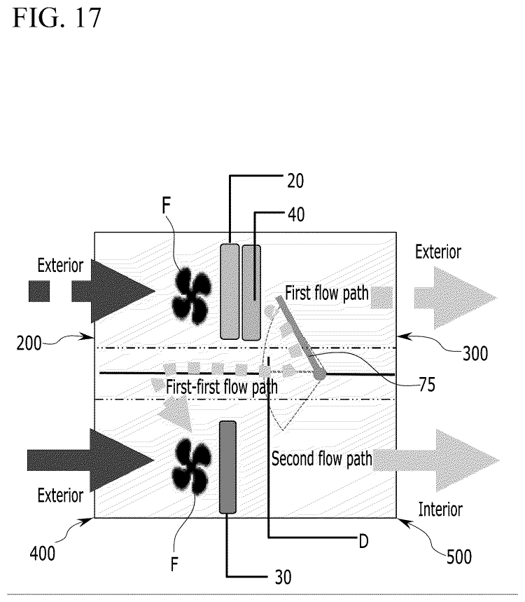

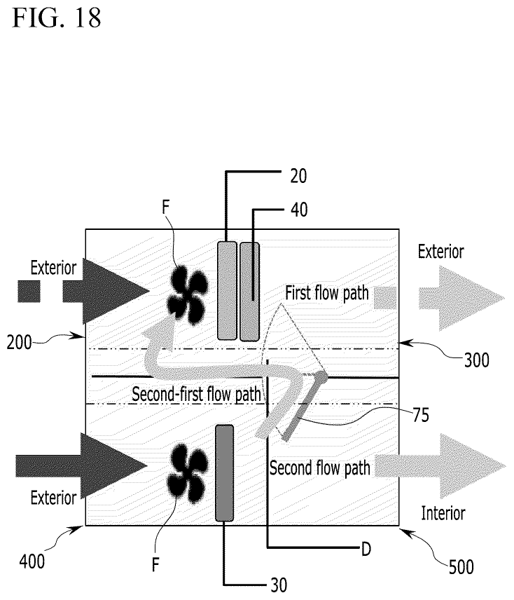

FIG. 16 is a circuit diagram illustrating a fluid flowing in the integrated thermal management system according to an embodiment of the present disclosure, when the outside air temperature is at a level lower than 25° C., the temperature of the battery and PE device is raised, and the interior is heated, FIG. 17 is a view illustrating an air flow in the air flow path for increasing heating efficiency and dehumidification in the case of FIG. 16, and FIG. 18 is a view illustrating an air flow in the air flow path for increasing heat exchange efficiency and improving heat pump performance in the case of FIG. 16.

With reference to FIG. 16, when the outside air temperature is at a level lower than 25° C., the temperature of the battery and the PE device is raised, and the interior is heated, in this case, the four-way valve 74 is operated in reverse, so that the first heat exchanger 50 and the second heat exchanger 60 may switch functions to function as a heat pump.

Both the first coolant pump 12 and the second coolant pump 14 are opened, and the three-way valve 72 is opened to the second heat exchanger 60 side.

The second heat exchanger 60 serves as the first heat exchanger, and the coolant is raised in temperature and delivered toward the PE device to raise the temperature of the PE device and delivered to the second radiator 30 to raise the temperature of the second radiator 30 side.

In addition, the first heat exchanger 50 serves as the second heat exchanger and collects waste heat collected from the PE device and delivers the waste heat to the first radiator 20 for heat exchange.

The interior heating is achieved by heat exchange of the second air flow path with the coolant raised in temperature through the second cooling circuit. With the closure of the three-way valve 72, the temperature-raised coolant of the second cooling circuit flows to the third cooling circuit to raise the temperature of the battery, collect the waste heat of the PE device, and raise the temperature of the combined coolant of the third cooling circuit to heat exchange with the first radiator 20, thereby improving the performance of the low-temperature heat pump, which allows the elimination of a coolant heater, PTC, and the like.

As illustrated in FIGS. 16 and 17, a portion of the temperature-raised air passing through the first air flow path may be introduced to the front of the second radiator 30 through the open flap valve 75, and the temperature-raised air may pass through the second radiator 30 and be introduced into the interior to increase the heating efficiency. In this case, dehumidification can be accomplished through the temperature-raised air.

In addition, as illustrated in FIGS. 16 and 18, a portion of the temperature-raised air passing through the second air flow path may be introduced to the front of the first radiator 20 through the open flap valve 75 to improve the heat exchange efficiency and the heat pump performance.

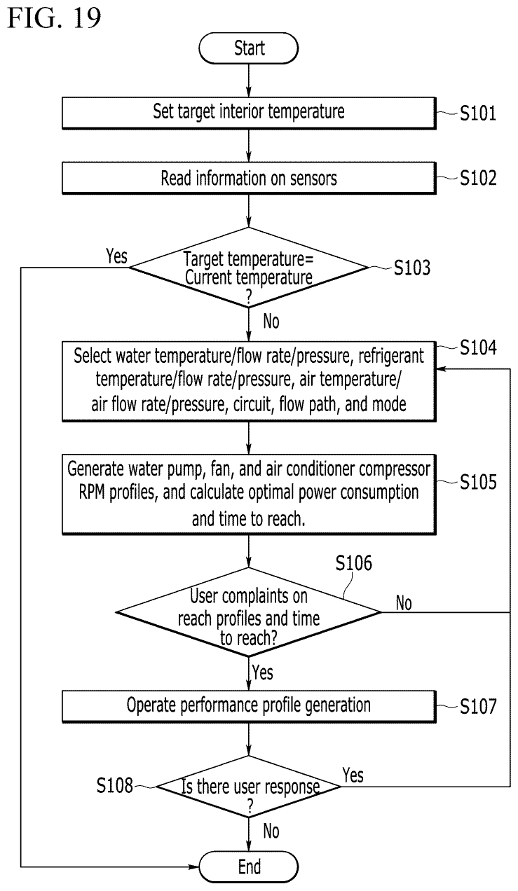

FIG. 19 is a flowchart illustrating a method of controlling the integrated thermal management system according to an embodiment of the present disclosure.

With reference to FIG. 19, a method of controlling the integrated thermal management system according to an embodiment of the present disclosure includes, first, setting a target interior temperature (S101) and reading, by a controller, information on sensors in the vehicle (S102). The information on the sensors in the vehicle may be the temperature, flow rate, and pressure of the coolant, the temperature, flow rate, and pressure of the refrigerant, and the temperature, air flow rate, and pressure of the air.

In this case, the controller may be implemented as one or more processors operated by a set program, in which the set program is programmed to perform each step of the method of controlling the integrated thermal management system according to an embodiment of the present disclosure.

Then, it is determined whether the current temperature is the same as the target temperature by the controller (S103). When the target temperature is not the same as the current temperature, the cooling circuit, the air flow path, and the mode of the integrated thermal management system illustrated in FIGS. 6 to 18 are selected through the information on the sensors read by the controller of the vehicle (S104).

Then, the RPM profiles of the coolant pump, the fan, and the first heat exchanger are generated by the controller in consideration of the optimal power consumption in the selected mode, and a time to reach is calculated (S105).

Then, the controller determines whether the generated profile and the time to reach are determined to be a complaint according to the predetermined propensity of the user (S106). When the RPM profile and the time to reach are determined to be a complaint, the controller adjusts and recalculates the profile, the time to reach, and the power consumption, and generates and operates a performance profile (S107).

Thereafter, the controller determines whether there is a response (S108), such as the user adjusting the interior temperature, and when it is determined that there is no response from the user, the performance profile is terminated.

As described above, according to an embodiment of the present disclosure, it is possible to configure the cooling and air conditioning systems to be applicable not only in electric vehicles but also in general residential facilities and to modularize the system for easy disassembly and assembly so that the system can be used universally across industries.

In addition, the cooling and air conditioning systems can be integrated to reduce wiring and piping, and the amount of refrigerant can be reduced to reduce cost and weight.

In addition, it is possible to configure the system to have heat exchange between air and coolant and between coolant and refrigerant and to have the efficient control of the entire system through the temperature of the coolant.

In addition, it is possible to improve the complexity of the system, such as reducing the heat exchanger, to improve efficiency and reduce costs by using the heat pump function, and to improve the function of the heat pump, which is difficult to use at extremely low temperatures, through the adjustment of the air flow path, thereby enabling the elimination of the PTC air conditioning heater and the coolant battery heater.

In addition, condensation and moisture generated inside the device after cooling operation can be removed and dehumidified through adjusting the internal air flow path.

In addition, it is possible to reduce FET application costs by switching all of the electric air conditioner compressor, the PTC heater, the coolant heater, the cooling fan, and the water pump that apply a high voltage to 48V, to reduce the number of components and control of current by unifying the power system of the device, and to select a motor with an optimal operating point in consideration.

In addition, it is possible to minimize energy consumption by calculating and adjusting the circuit of the heat exchanging device, the flow rate and temperature of the flow path, the pressure, and the target temperature time.

While the exemplary embodiments of the present disclosure have been described, the embodiments of the present disclosure are not limited to the exemplary embodiments. The embodiments of the present disclosure cover all modifications that can be easily made from the exemplary embodiments of the present disclosure by those skilled in the art and considered as being equivalent to the exemplary embodiments of the present disclosure.

What is claimed is:

1. An integrated thermal management system for a vehicle-mounted power electric (PE) device and a vehicle interior, the integrated thermal management system comprising:
a reservoir configured to store a coolant;
a first cooling circuit in which the coolant branched and supplied from the reservoir circulates and passes through a first heat exchanger and a first radiator;
a second cooling circuit in which the coolant branched and supplied from the reservoir circulates and passes through a second heat exchanger and a second radiator;
a third cooling circuit in which the coolant branched and supplied from the reservoir circulates and passes through a third radiator and passes through the first radiator of the first cooling circuit; and
a fourth cooling circuit comprising a compressor in heat exchange with the first heat exchanger and the second heat exchanger, wherein the first cooling circuit, the second cooling circuit, the third cooling circuit, and the fourth cooling circuit are configured to heat exchange through the same coolant.

2. The integrated thermal management system of claim 1, further comprising:
a first mode in which heat exchange of the third cooling circuit is performed;
a second mode in which the second cooling circuit and the first cooling circuit are operated in parallel;
a third mode in which the second cooling circuit is branched from a branch point of the second cooling circuit, coupled to the third cooling circuit in series and passes through the third cooling circuit, and coupled to the first cooling circuit at a branch point of the first cooling circuit;
a fourth mode in which the second cooling circuit and the first cooling circuit are operated in parallel and the second cooling circuit and the third cooling circuit are operated in parallel; and
a fifth mode in which the second cooling circuit and the first cooling circuit are operated in parallel and the second cooling circuit is branched from the branch point of the second cooling circuit and operated with the third cooling circuit in parallel to be coupled to a first heat exchange loop at a branch point of the first heat exchange loop.

3. The integrated thermal management system of claim 2, further comprising a three-way valve configured to open and close to control the first mode, the second mode, the third mode, the fourth mode, and the fifth mode.

4. The integrated thermal management system of claim 3, further comprising a first coolant pump configured to deliver the coolant branched and supplied from the reservoir through a first coolant flow path in the first cooling circuit.

5. The integrated thermal management system of claim 4, further comprising a second coolant pump configured to deliver the coolant branched and supplied from the reservoir through a second coolant flow path in the second cooling circuit.

6. The integrated thermal management system of claim 5, further comprising a battery and a PE device configured to be cooled in the third cooling circuit by the coolant branched and supplied from the reservoir, the coolant being introduced through a third coolant flow path by operation of the three-way valve.

7. The integrated thermal management system of claim 6, further comprising:
a four-way valve configured to be connected to a refrigerant passing through the compressor and to select and control one of the first heat exchanger and the second heat exchanger to serve as the first heat exchanger; and
an expansion valve configured to expand condensed refrigerant in the fourth cooling circuit.

8. The integrated thermal management system of claim 7, further comprising an accumulator in a flow path before passing through the compressor.

9. The integrated thermal management system of claim 7, wherein:
a first air flow path is defined in which air flows from the first radiator to the third radiator;
a second air flow path is defined in which air flows from the second radiator to the vehicle interior; and
a flap valve is disposed between the first air flow path and the second air flow path and is configured to be opened and closed to allow air to pass selectively.

10. The integrated thermal management system of claim 9, wherein, in a state in which the PE device is mounted on a vehicle and the vehicle is heated or cooled:
in the first air flow path, of air introduced from an exterior and air delivered from the second air flow path, a first portion is delivered to the exterior and a second portion is delivered to the second radiator in front of the second air flow path; and
in the second air flow path, of air introduced from the exterior and a third portion of air delivered from the first air flow path, a fourth portion is delivered to the vehicle interior and a fifth portion is delivered to the first radiator in front of the first air flow path.

11. The integrated thermal management system of claim 9, wherein, in a state in which an outside air temperature is at a level of 25° C. and the battery and the PE device are normally cooled, the first coolant pump is stopped, the three-way valve is opened toward the PE device, a cut off valve of the third radiator is opened, and the compressor is stopped, such that the PE device is cooled through the coolant flowing through the third cooling circuit.

12. The integrated thermal management system of claim 11, wherein the second radiator is stopped and the flap valve is closed so that air introduced from an exterior passes through the first radiator and the third radiator and is cooled and discharged to the exterior.

13. The integrated thermal management system of claim 9, wherein, in a state in which an outside air temperature is at a level of 25° C. and heat generation of the PE device is high, both the first coolant pump and the second coolant pump are opened, the three-way valve is opened toward the second heat exchanger, and the coolant circulates through the compressor, the four-way valve, the first heat exchanger, the expansion valve, and the second heat exchanger, such that the coolant flowing through the first heat exchanger cools the refrigerant, and the coolant is cooled through the refrigerant in the second heat exchanger and delivered toward the PE device to cool the PE device.

14. The integrated thermal management system of claim 13, wherein the second radiator is stopped and the flap valve is closed such that air introduced from an exterior passes through the first radiator and the third radiator and is cooled and discharged to the exterior.

15. The integrated thermal management system of claim 9, wherein, in a state in which an outside air temperature is at a level higher than 25° C.:
both the first coolant pump and the second coolant pump are opened and the three-way valve is opened;
the coolant is delivered toward the PE device through a branch point to cool the PE device; and
the refrigerant circulates through the compressor, the four-way valve, the first heat exchanger, the expansion valve, and the second heat exchanger such that the coolant flowing through the first heat exchanger cools the refrigerant, and the coolant is cooled through the refrigerant in the second heat exchanger and passes through the second radiator.

16. The integrated thermal management system of claim 15, wherein the first radiator, the second radiator, and the third radiator are all operated and the flap valve is closed such that cold air passing through the second radiator is introduced into the interior.

17. The integrated thermal management system of claim 7, wherein, in a state in which an outside air temperature is at a level higher than 25° C. and heat generation of the PE device is high:
both the first coolant pump and the second coolant pump are opened and the three-way valve is opened toward the second heat exchanger;
the coolant is delivered from the second heat exchanger toward the PE device to cool the PE device; and
the refrigerant circulates through the compressor, the four-way valve, the first heat exchanger, the expansion valve, and the second heat exchanger such that the coolant flowing through the first heat exchanger cools the refrigerant, and the coolant is cooled through the refrigerant in the second heat exchanger and passes through the second radiator.

18. The integrated thermal management system of claim 7, wherein, in a state in which an outside air temperature is at a level higher than 25° C. and only the interior is cooled:
both the first coolant pump and the second coolant pump are opened
the three-way valve is opened toward the second heat exchanger; and
the refrigerant circulates through the compressor, the four-way valve, the first heat exchanger, the expansion valve, and the second heat exchanger such that the coolant flowing through the first heat exchanger cools the refrigerant, and the coolant is cooled through the refrigerant in the second heat exchanger and passes through the second radiator.

19. The integrated thermal management system of claim 7, wherein, in a state in which an outside air temperature is at a level lower than 25° C., the temperature of the battery and the PE device is raised, and the interior is heated, the four-way valve is operated in reverse such that the first heat exchanger and the second heat exchanger switch functions to function as a heat pump.

20. A method of controlling an integrated thermal management system, the method comprising:
setting a target temperature;
reading information on sensors;
determining a difference between the target temperature and a current temperature;
identifying a number of cases with a combination of modes to achieve the target temperature;
identifying a mode of optimal energy consumption and a time to reach; and
determining whether a user is satisfied with the time to reach, wherein a performance profile is operated to change a time by changing a mode in a case in which there is a response from the user.
